(19) United States
(12) Patent Application Publication
(10) Pub. No.: US 2012/0328371 A1
(43) Pub. Date: Dec. 27, 2012

(54) SYSTEMS AND METHODS FOR MAKING SUBSEA FLUID CONDUIT CONNECTIONS

(75) Inventors: Eric Joseph Munstereifel, Cypress, TX (US); Daniel Gutierrez, Houston, TX (US); Luis Javier Gutierrez, Houston, TX (US)

(73) Assignee: BP CORPORATION NORTH AMERICA INC., Houston, TX (US)

(21) Appl. No.: 13/455,606

(22) Filed: Apr. 25, 2012

Related U.S. Application Data
(60) Provisional application No. 61/479,117, filed on Apr. 26, 2011.

(51) Int. Cl. F16L 37/00; F16L 1/12

(52) U.S. Cl. 405/169; 285/38

(57) ABSTRACT

A fluid conduit system for coupling a pair of subsea components comprises a fluid conduit. In addition, the system comprises a first quick disconnect member coupled to a first end of the fluid conduit. The first quick disconnect member is configured to releasably mate and engage a second quick disconnect member coupled to one of the pair of subsea components. Further, the system comprises a handle coupled to the first quick disconnect member. The handle is configured to be grasped and manipulated by a subsea ROM.

### CROSS-REFERENCE TO RELATED APPLICATIONS

This application claims benefit of U.S. provisional patent application Ser. No. 61/479,117 filed Apr. 26, 2011, and entitled “Systems and Methods for Making Subsea Fluid Conduit Connections,” which is hereby incorporated herein by reference in its entirety.

### STATEMENT REGARDING FEDERALLY SPONSORED RESEARCH OR DEVELOPMENT

Not applicable.

### BACKGROUND

1. Field of the Invention

This disclosure relates generally to systems and methods for making subsea fluid conduit connections. More particularly, this disclosure relates to systems and methods for making subsea fluid conduit connections through the use of remotely operated manipulators.

2. Background of the Technology

In hydrocarbon drilling and production operations, it is common to provide a subsea hydraulically powered system and, in some cases, to provide such systems near the sea floor. It is also common to provide an associated subsea hydraulic power source to a location near the hydraulically powered system. The hydraulically powered system and the associated hydraulic power source are typically connected in fluid communication via a fluid conduit that is also located subsea. In most cases, the hydraulically powered system and the associated hydraulic power source include threaded adapters configured to interface with threaded fittings on the ends of the fluid conduit. For example, the hydraulic powered system and the associated hydraulic power source often include common threaded male fittings and/or nipples configured for attachment to common threaded nuts to provide fluid-tight connections. Under some circumstances, one or both of the above-described hydraulically powered system and hydraulic power source are located a substantial distance from the sea surface, such that repairs require a time-consuming retrieval of the hydraulically powered system and/or hydraulic power source to the surface, followed by a time-consuming deployment of a new or repaired hydraulically powered system and/or hydraulic power source. Alternatively, remotely operated manipulators (ROMs) carried by remotely operated vehicles (ROVs) or manned submarines can be employed to perform maintenance subsea without substantially relocating the hydraulically powered system and/or the hydraulic power source.

In some cases, the above-described fluid conduit can become severed, damaged, or otherwise present cause for repair and/or replacement. In other cases, one or both of the above-described hydraulically powered systems and hydraulic power sources can similarly become damaged, inoperable, or otherwise present cause for repair and/or replacement. It is common to attempt such repair and/or replacement through the use of ROMs, but precisely controlling ROMs subsea can be challenging. Such difficulty in controlling ROMs during subsea operations to repair and/or replace one of the above-described components introduces a risk of damaging mating threading components (e.g., cross-threading). Controlling ROMs subsea to perform operations to repair and/or replace one or more of the above-described components can still further be complicated by an ROM having to contend with the forces resulting from the twisting, turning, kinking, spinning, and/or other movement of the fluid conduit, as can occur for example, while attempting to establish fluid-tight connections between mating components.

Accordingly, there remains a need in the art for systems and methods for repairing and/or replacing components of subsea hydraulic systems. Such systems and methods would be particularly well-received if they were suitable for replacing and/or repairing components of subsea hydraulic systems in situations where the retrieval of one or more of the system components to the surface is uneconomical, too time consuming, and/or not achievable.

### BRIEF SUMMARY OF THE DISCLOSURE

These and other needs in the art are addressed in one embodiment by a fluid conduit system for coupling a pair of subsea components. In an embodiment, the system comprises a fluid conduit. In addition, the system comprises a first quick disconnect member coupled to a first end of the fluid conduit. The first quick disconnect member is configured to releasably mate and engage a second quick disconnect member coupled to one of the pair of subsea components. Further, the system comprises a handle coupled to the first quick disconnect member. The handle is configured to be grasped and manipulated by a subsea ROM.

These and other needs in the art are addressed in another embodiment by a method for making a subsea fluid conduit connection. In an embodiment, the method comprises (a) connecting a first portion of a two portion quick disconnect device to a subsea component. In addition, the method comprises (b) connecting a second portion of the two portion quick disconnect device to a fluid conduit. Further, the method comprises (c) releasably connecting the first portion to the second portion subsea with a subsea ROM by inserting the first portion into the second portion.

These and other needs in the art are addressed in another embodiment by a method for replacing a first subsea hydraulic power source connected to a subsea hydraulically powered system with a first fluid conduit. In an embodiment, the method comprises (a) disconnecting the first fluid conduit from the subsea hydraulically powered system. In addition, the method comprises (b) deploying a second hydraulic power source subsea, wherein a second fluid conduit has a first end connected to the second hydraulic power source and a second end coupled to a first portion of a two portion quick disconnect device. Further, the method comprises (c) coupling a second portion of the two portion quick disconnect device to the hydraulically powered system subsea. Still further, the method comprises (d) releasably connecting the first portion to the second portion subsea with a subsea ROM after (b).

Thus, embodiments described herein include a combination of features and advantages intended to address various shortcomings associated with certain prior devices, systems, and methods. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the preferred embodiments of the disclosure, reference will now be made to the accompanying drawings in which:

FIG. 1 is an oblique view of a fluid conduit system in accordance with the principles described herein;

FIG. 2 is another oblique view of the fluid conduit system of FIG. 1;

FIG. 3 is an orthogonal side view of the fluid conduit system of FIG. 1 shown in a disconnected state from a subsea device;

FIG. 4 is an orthogonal side view of the fluid conduit system of FIG. 1 shown connected to a subsea device;

FIG. 5 is a schematic view showing an initial conventional fluid conduit connection between subsea devices;

FIG. 6 is a schematic view showing removal of a conventional threaded connector from a subsea device;

FIG. 7 is a schematic showing a conventional fluid conduit disconnected from a subsea device;

FIG. 8 is a schematic view showing recovery of a hydraulic power source from a seabed;

FIG. 9 is a schematic view showing installation of a portion of a quick connect device of the system of FIG. 1;

FIG. 10 is a schematic showing a portion of a quick connect device of FIG. 1 installed on a hydraulically powered system;

FIG. 11 is a schematic showing removal of a conventional fluid conduit from a recovered hydraulic power source;

FIG. 12 is a schematic view showing installation of the fluid conduit system of FIG. 1 to a recovered hydraulic power source;

FIG. 13 is a schematic view showing an ROV and ROM manipulating a fluid conduit system of FIG. 1 that is connected to a deployed hydraulic power source;

FIG. 14 is a schematic view showing an ROV and ROM connecting a first portion of a quick connect device of the fluid conduit system of FIG. 1 to a second portion of the quick connect device of the fluid conduit system of FIG. 1;

FIG. 15 is a schematic view showing a fluid conduit system of FIG. 1 installed to both a hydraulic power source and a hydraulically powered system;

FIG. 16 is a schematic view of a fluid conduit system of FIG. 1 as situated for making a subsea fluid conduit connection according to the principles described herein;

FIG. 17 is another simplified schematic view of another step of the method of FIG. 16; and

FIG. 18 is another simplified schematic view of another step of the method of FIG. 16.

### DETAILED DESCRIPTION OF THE PREFERRED EMBODIMENTS

The following discussion is directed to various embodiments of the disclosure. Although one or more of these embodiments may be preferred, the embodiments disclosed should not be interpreted, or otherwise used as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to, . . . .” Also, the term “couple” or “couples” is intended to mean either an indirect or direct connection. Thus, if a first device couples to a second device, that connection may be through a direct engagement of the two devices, or through an indirect connection via other intermediate devices, components, and connections. In addition, as used herein, the terms “axial” and “axially” generally mean along or parallel to a given axis (e.g., central axis of a body or a port), while the terms “radial” and “radially” generally mean perpendicular to the axis. For instance, an axial distance refers to a distance measured along or parallel to the axis, and a radial distance means a distance measured perpendicular to the axis. As used herein, the term “quick disconnect” refers to a component that is releasably connected to another component solely through relative axial movement (i.e., pressing the components together), and thus, does not require relative rotation, engagement of mating threads, or external clamps.

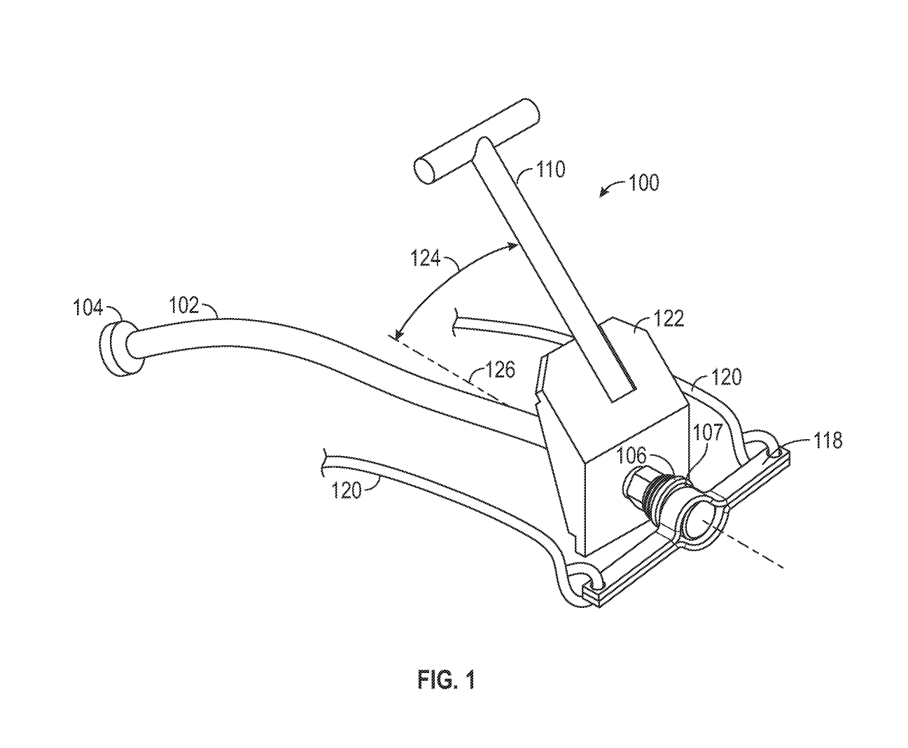

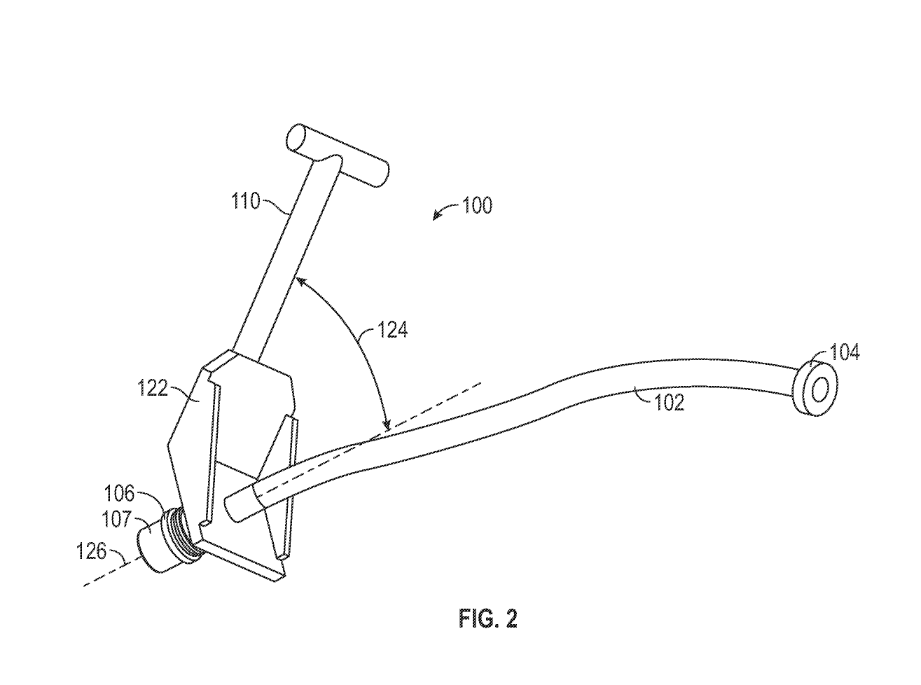

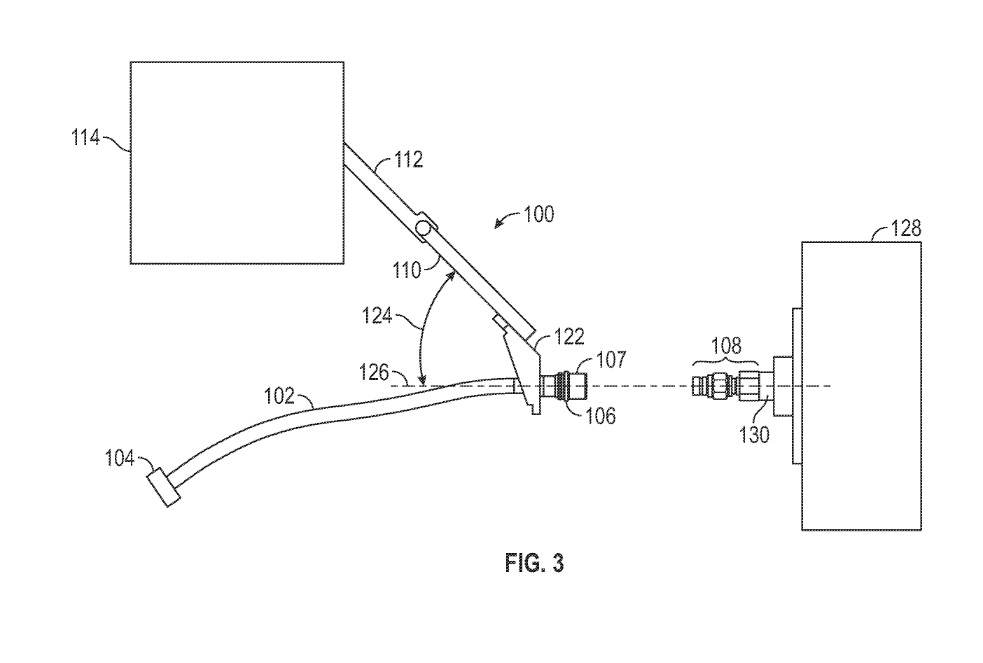

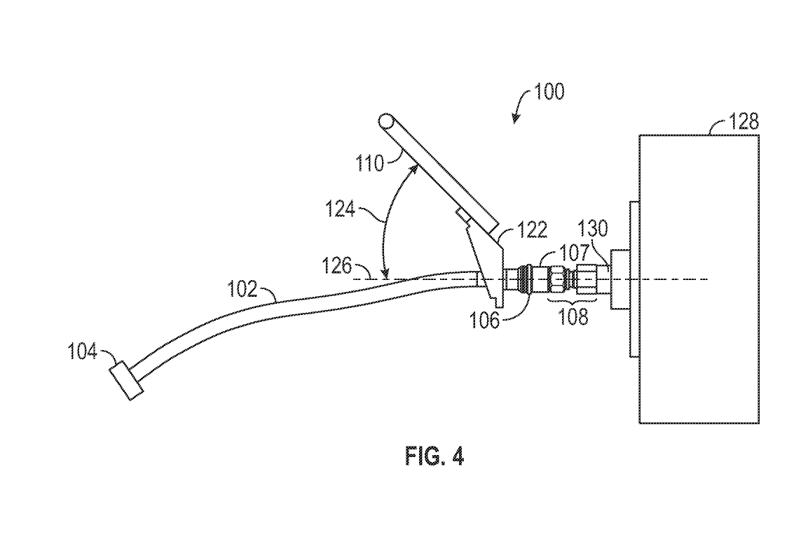

Referring now to FIGS. 1-4, an embodiment of a fluid conduit system 100 is shown. FIGS. 1 and 2 show oblique views of the fluid conduit system 100, while FIGS. 3 and 4 show orthogonal side views of the fluid conduit system 100 in various stages of assembly relative to other devices. In this embodiment, fluid conduit system 100 includes a fluid conduit 102 (e.g., a flexible hydraulic hose), a threaded female nut 104 coupled to one end of the fluid conduit 102, and a quick disconnect (QD) receptacle 106 coupled to the opposite end. The female QD receptacle 106 has a central axis 126 and includes an inner profile that is complementary to an outer profile of a mating male QD plug 108 installed on a device prior to connection with QD receptacle 106. In some embodiments, the QD plug 108 and the QD receptacle 106 have inner flow bore diameters equal to or greater than the inner diameter of the fluid conduit 102 and/or the inner diameter of the device to which the QD plug 108 is connected. By providing the QD receptacle 106 and the QD plug 108 with inner diameters greater than the fluid conduit 102 and the device connected to QD plug 108, the fluid conduit system 100 can be referred to as a “full bore” connection that allows full-pressure service for high fluid flow rates and high pressure through the fluid conduit system 100. In general, the QD receptacle 106 and QD plug 108 may be any quick disconnect receptacle suitable for subsea use and the anticipated fluid pressures and flow rates. In this embodiment, the QD receptacle 106 is a non-spill hydraulic quick-release coupling receptacle for high pressure hydraulic circuits manufactured by Stäubli Faverges as part number SPX 06.1152, and the QD plug 108 is a non-spill hydraulic quick-release coupling plug for high pressure hydraulic circuits manufactured by Stäubli Faverges as part number SPX 06.7152.

As best shown in FIG. 1, the QD receptacle 106 further includes a mechanical release mechanism 107 configured to selectively disconnect the QD receptacle 106 from the QD plug 108. In this embodiment, the release mechanism 107 is a slidable sleeve. One example of a quick-disconnect receptacle with a slidable sleeve release device is the quick release coupling available from Stäubli Faverges of Switzerland. A pulling collar 118 is mounted to release mechanism 107 and a pair of pull handles 120 are coupled to collar 118. For purposes of clarity, collar 118 and handles 120 are only shown in FIG. 1. In this embodiment, pull handles 120 are cables that can be pulled by a ROM 112 to pull collar 118 and release mechanism 107 coupled thereto, thereby allowing the separation of the QD receptacle 106 from the QD plug 108.

Referring again to FIG. 1-4, in this embodiment, the QD receptacle 106 is connected to a handle 110 with a rigid support or frame 122. The handle 110 is configured to provide a convenient structure for a ROM 112 of an ROV 114 to grasp and control to manipulate the position and orientation of the QD receptacle 106 (FIG. 3). In this embodiment, the handle 110 is a T-handle, however, in general, the handle (e.g., handle 110) can have other geometries suitable for being grasped by a ROM 112 (e.g., a fishtail handle). Because the handle 110 is configured for handling by a ROM 112, the QD receptacle 106 is well suited for being extended, retracted, displaced, and/or otherwise manipulated subsea by a ROM 112 of an ROV 114. Frame 122 is sized and configured to allow the handle 110 to extend toward the QD receptacle 106 at an angular offset 124 measured from the axis 126 of the QD receptacle 106. In this embodiment, the angular offset 124 is 45 degrees. However, in other embodiments, the angular offset can be any other value and/or may not be angularly offset. The connection between the handle 110 and the QD receptacle 106 via the frame 122 is sufficiently stiff to reliably allow application of a substantial force to the QD receptacle 106 in a direction parallel to the axis 126, and in some cases, without the ROV 114 and/or the ROM 112 actually being located substantially aligned with the axis 126.

Referring now to FIGS. 3 and 4, the fluid conduit system 100 is shown being releasably connected to a subsea device 128. First, a QD plug 108 as previously described is connected to a threaded fluid connector 130 of the device 128. Next, an ROV 114 and/or ROM 112 are operated to substantially coaxially align the QD receptacle 106 with the QD plug 108. While maintaining such alignment, the QD receptacle 106 is moved towards the QD plug 108. The QD plug 108 is inserted into and advanced through the QD receptacle 106 until the QD plug 108 is fully seated in the QD receptacle 106 and a fluid tight so-called quick connect action through mechanical interaction between the QD plug 108 and the QD receptacle 106 is achieved. Once the configuration shown in FIG. 4 is accomplished, fluid can selectively flow between the device 128 and whatever other device the fluid conduit 102 is attached. In some embodiments, additional ROVs 114 and/or ROMs 112 can be utilized to pull the release mechanism 107 axially away from the device 128 to allow disconnection of the fluid conduit system 100 from the device 128. While the system 100 has been described above with particularity, in other embodiments, one or more of the mating system 100 components can be reversed relative to each other (such as male and female components being located in different orders along a fluid flow path of the system 100) and/or relative to other devices (such as providing a male component rather than a female component for connection to a device).

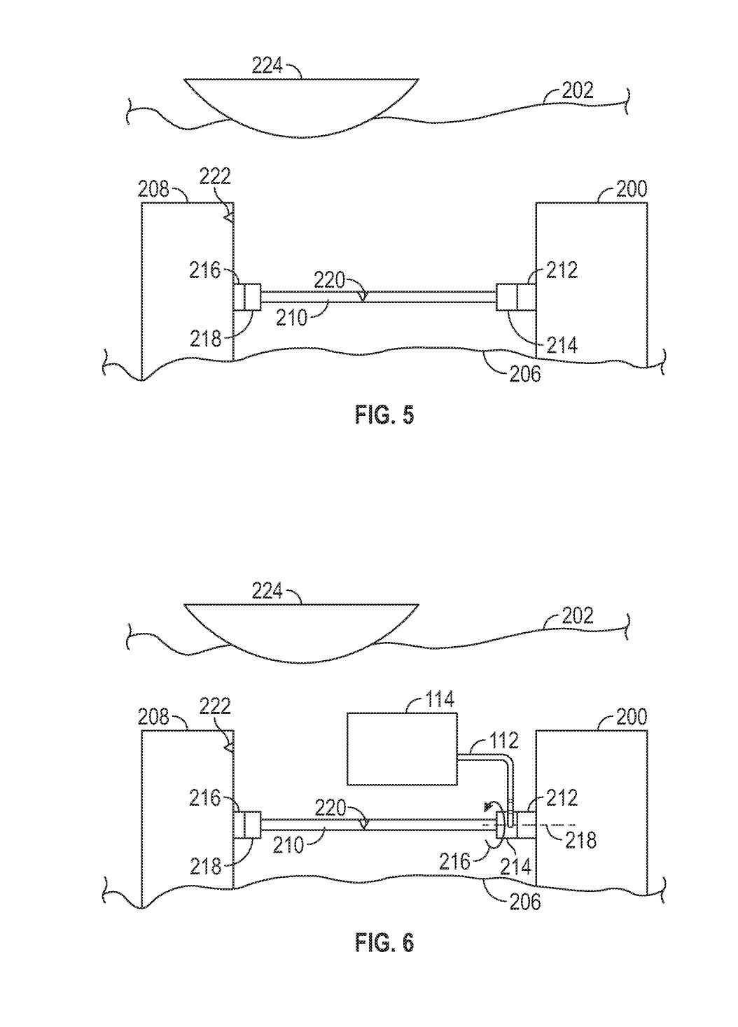

Referring now to FIGS. 5-15, the fluid conduit system 100 is shown in the various operational steps for connecting subsea devices. FIG. 5 shows a vessel 224 positioned at the sea surface 202, a subsea hydraulically powered system 200 disposed on the seabed 206, and a subsea hydraulic power source 208 that is also located on the seabed 206. The hydraulically powered system 200 is connected to the hydraulic power source 208 via a conventional fluid conduit 210. More specifically, the hydraulically powered system 200 includes a hydraulic bulkhead connection 212 that, in this example, is an externally threaded male fitting protruding outward from the hydraulically powered system 200, and the fluid conduit 210 includes a mating, internally threaded female nut 214 to selectively threadably engage the hydraulic bulkhead connection 212 to produce a fluid tight seal between the fluid conduit 210 and hydraulically powered system 200. Still further, the hydraulic power source 208 includes an external hydraulic fitting 216 (similar to the hydraulic bulkhead connection 212) and connected to an internally threaded female nut 218 (similar to the threaded female nut 214) to produce a fluid tight seal between the hydraulic power source 208 and the fluid conduit 210. In other embodiments, the connectors of the fluid conduit 210, hydraulically powered system 200, and/or the hydraulic power source 208 may be different, such as, but not limited to so-called JIC connectors as are known in the industry. FIG. 5 schematically shows that the fluid conduit 210 and the hydraulic power source 208 include damaged areas 220, 222, respectively, that warrant repair and replacement, respectively.

Referring now to FIG. 6, an ROV 114 having an ROM 112 is shown disconnecting the fluid conduit 210 from the hydraulically powered system 200. Specifically, the ROM 112 is employed to directly grasp the threaded female nut 214 (or use a suitable wrench to engage the female nut 214), and rotate the threaded female nut 214 relative to the hydraulic bulkhead connection 212 to unthread the female nut 214 from the hydraulic bulkhead connection 212. The above-described rotation is indicated by arrow 216 which shows that rotation of the threaded female nut 214 is generally about the central axis 218 of the hydraulic bulkhead connection 212. The rotation is depicted as counter-clockwise from a viewpoint of the QD receptacle 106, but in other embodiments may be clockwise, dependent upon the thread direction of the female nut 214 and the hydraulic bulkhead connection 212.

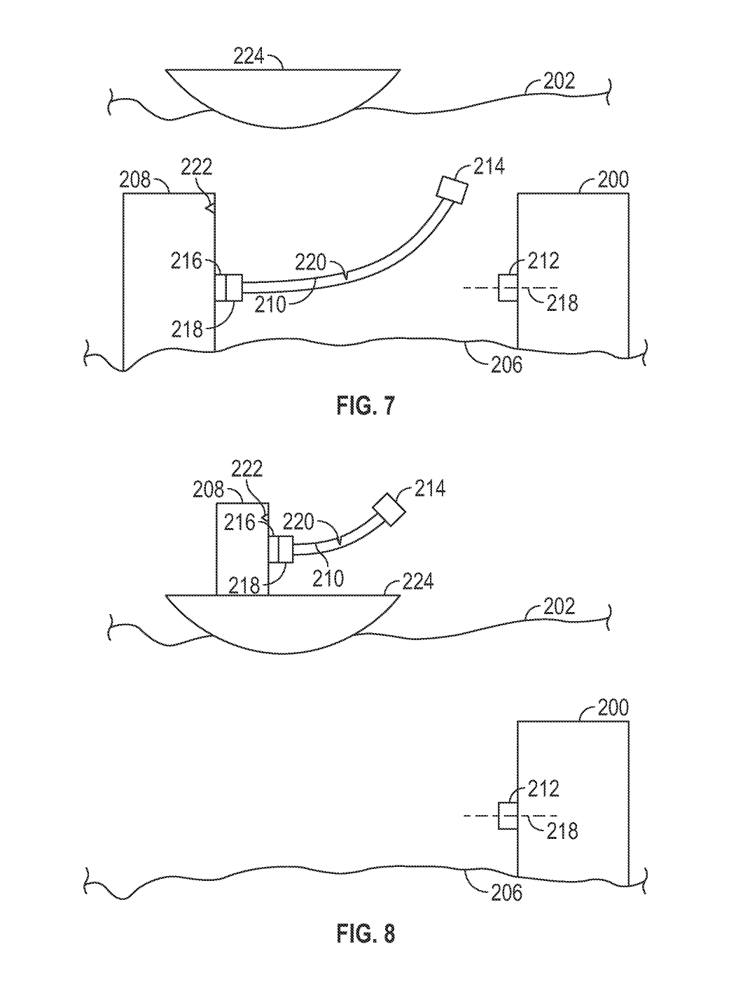

Referring now to FIG. 7, the fluid conduit 210 is shown as being successfully disconnected from the hydraulically powered system 200 by fully unthreading female nut 214 from the hydraulic bulkhead connection 212, and thereafter moving the fluid conduit 210 away from the hydraulic bulkhead connection 212. In alternative embodiments, the fluid conduit 210 may be cut or severed prior to removing the threaded female nut 214.

Referring now to FIG. 8, in this embodiment, the hydraulic power source 208 is recoverable (i.e., capable of being removed to the surface 202), however, the hydraulically powered system 200 is generally not recoverable. Thus, the hydraulic power source 208 and the fluid conduit 210 coupled thereto are retrieved from the seabed 206 and disposed on the vessel 224. In alternative embodiments, the fluid conduit 210 and associated connectors may be recovered separately from and/or without recovering the hydraulic power source 208.

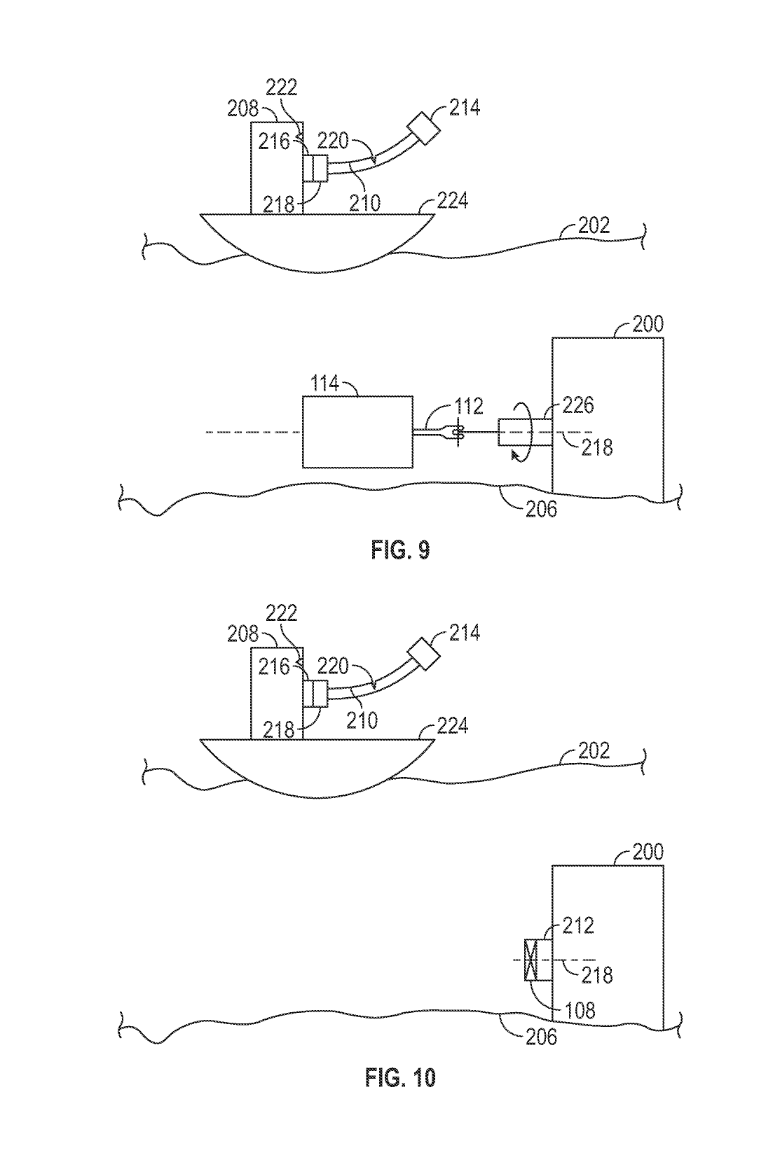

Referring to FIG. 9, the ROV 114 and the ROM 112 are shown using a T-handle deep socket tool 226 to install a QD plug 108 as previously described to the hydraulically powered system 200. In FIG. 9, the QD plug 108 is hidden from view because it is disposed within the T-handle deep socket tool 226. In this embodiment, the ROV 114 remains substantially stationary while the ROM 112 holds the T-handle deep socket tool 226 and the associated QD plug 108 substantially coaxially aligned with the axis 218, and simultaneously rotates the T-handle deep socket tool 226 to thread the QD plug 108 to the hydraulic bulkhead connection 212 until a fluid tight seal is achieved.

Referring now to FIG. 10, with QD plug 108 sufficiently threaded to the hydraulic bulkhead connection 212, the ROV 114 and/or the ROM 112 remove the T-handle deep socket tool 226 from the QD plug 108 by pulling the T-handle deep socket tool 226 away from the hydraulic bulkhead connection 212 in a direction substantially aligned with axis 218. The ROV 114 and the ROM 112 may relocate after installation of the QD plug 108.

Referring now to FIG. 11, the fluid conduit 210 and associated threaded female nuts 214, 218 are removed from the hydraulic power source 208 at the surface 202. However, the external hydraulic fitting 216 remains coupled to the hydraulic power source 208. In addition, the hydraulic power source 208 is repaired aboard vessel 224.

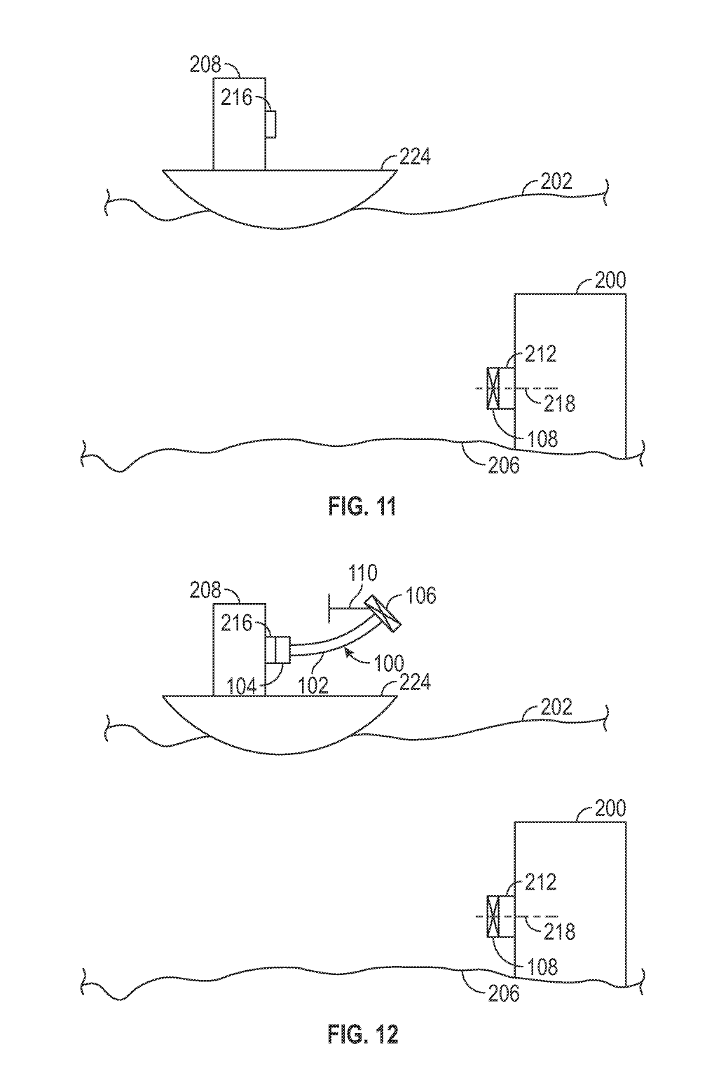

Referring now to FIG. 12, a fluid conduit system 100 as previously described is attached to the external hydraulic fitting 216 of the hydraulic power source 208 at the surface 202. In alternative embodiments, the fluid conduit system may comprise another QD receptacle 106 and QD plug 108 set ultimately installed between the fluid conduit system 100 and the hydraulic power source 208.

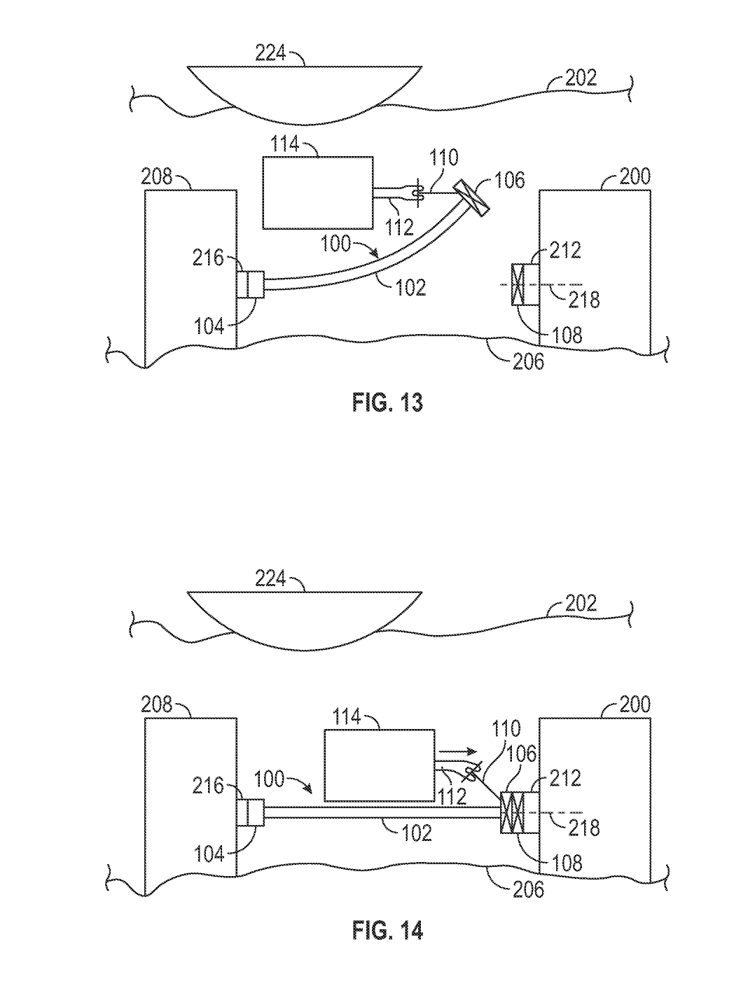

Referring now to FIG. 13, the hydraulic power source 208 and the fluid conduit system 100 coupled thereto are deployed subsea and disposed on the seabed 206. With the hydraulic power source 208 supported in a substantially stationary position relative to the hydraulically powered system 200, an ROV 114 and an associated ROM 112 are used to manipulate the position of the QD receptacle 106 via the handle 110.

Referring now to FIG. 14, the ROV 114 and the associated ROM 112 move the QD receptacle 106 substantially into coaxial alignment with the QD plug 108. Next, the ROV 114 and the associated ROM 112 connect the QD receptacle 106 to the QD plug 108. In particular, the ROV 114 and the associated ROM 112 advance the QD receptacle 106 over the QD plug 108 until a so-called quick connect action is accomplished through mechanical interaction between the QD plug 108 and the QD receptacle 106, thereby providing a fluid tight seal between the fluid conduit system 100 and the hydraulically powered system 200.

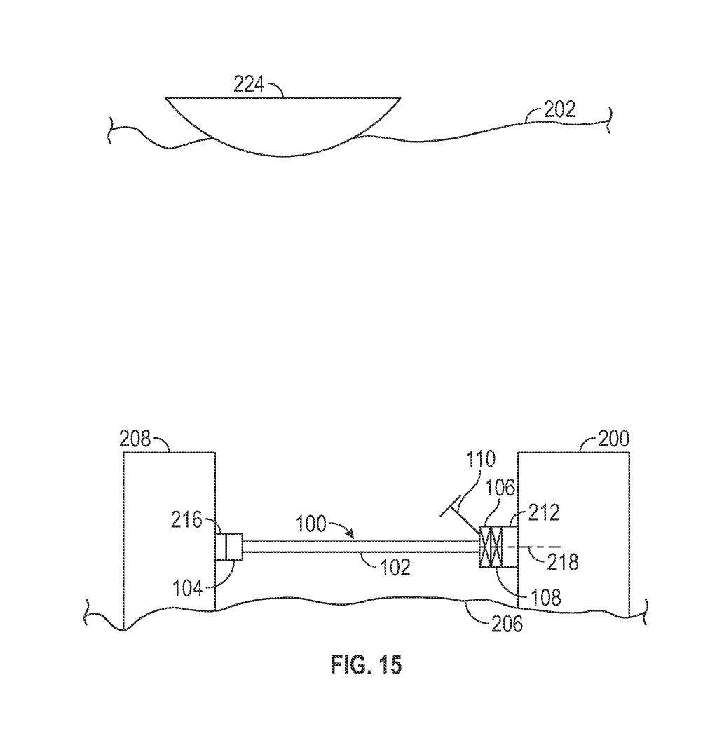

Referring now to FIG. 15, once the above-described fluid tight seal between the fluid conduit system 100 and the hydraulically powered system 200 is achieved, the ROV 114 and the associated ROM 112 release the handle 110 of the fluid conduit system 100, thereby completing the connection of the hydraulically powered system 200 and the hydraulic power source 208 via a fluid conduit system 100.

While the above-described steps of installing a fluid conduit system are explained above in a particular order, the actions can be taken in any other suitable order to achieve a substantially similar resultant subsea fluid conduit connection. Further, while some of the above-described actions related to installing a fluid conduit system 100 were described with particularity with regard to where in the body of water 204 the actions occurred, in alternative embodiments, one or more of the actions can take place at higher or lower depths, at the surface 202 of the body of water 204, and/or above the surface 202. Still further, it will be appreciated that the relative location of the QD plug 108 and the QD receptacle 106 along the axis 218 of the hydraulic bulkhead connection 212 can be reversed. In other words, the QD plug 108 may be disposed on the end of conduit 102 and the QD receptacle 106 may be coupled to system 200. Additionally, it will be appreciated that in alternative embodiments, other devices and/or fluid connectors can replace the hydraulically powered system 200 and the hydraulic power source 210 while still retaining the actions necessary to make a subsea fluid conduit connection using a fluid conduit system 100 and/or a fluid conduit system substantially similar to fluid conduit system 100. In some embodiments, the fluid connection between the external hydraulic fitting 216 and the threaded female nut 104 can be replaced by a quick disconnect connection substantially similar to that described above with regard to the use of the QD plug 108 and the QD receptacle 106.

In at least some of the embodiments described above, the provision of the systems and methods for making subsea fluid conduit connections herein can reduce difficulty related to subsea fluid conduit replacement by requiring only one ROV 114 and/or one ROM 112 to perform the methods. Additionally, the provision of the systems and methods for making subsea fluid conduit connections herein can lower the level of control skill required to operate ROV 114 and/or ROM 112 and to successfully achieve subsea fluid conduit connections. Particularly, the systems and methods disclosed herein can negate any need to control a wrench-like device to join threaded components which inherently includes the risk that ROV 114 and/or ROM 112 operator error and/or environmental circumstances can contribute to cross-threading and thus damaging mating components. Still further, the systems and methods disclosed herein can allow a reduction in fluid conduit twisting, kinking, or resisting ROV 114 movements during fluid conduit installation as compared to other practices of connecting fluid conduits via standard threaded fluid conduit fittings. More specifically, by substituting the quick disconnect devices 106, 108 in place of a single female nut 214 or other device requiring screw-like rotation to achieve a connection, the rotation conventionally associated with such conventional devices is unnecessary and the fluid conduit 102 is therefore not twisted during installation.

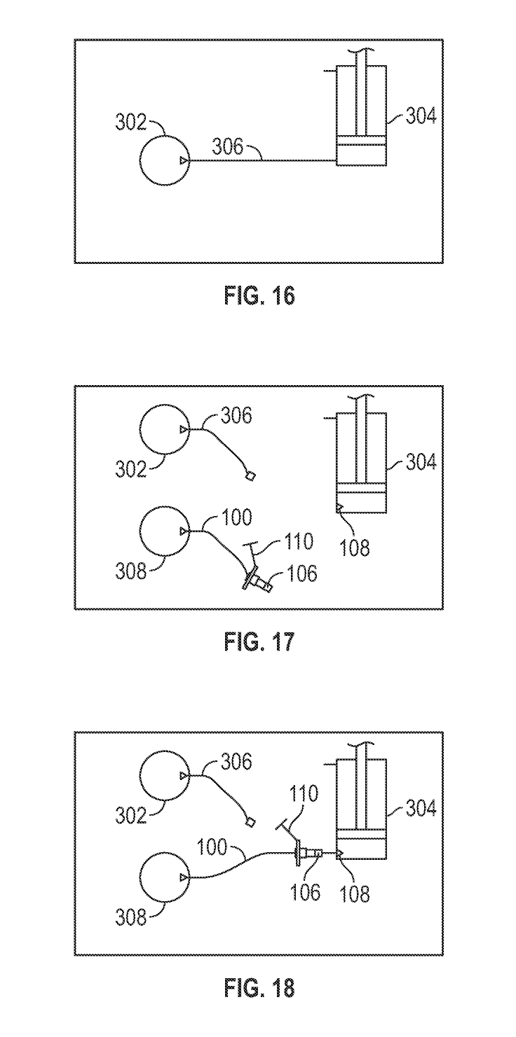

Referring now to FIGS. 16-18, operational steps for making a subsea fluid conduit connection using a fluid conduit system 100 are shown in simplified schematic drawings. In some cases, as described above, a subsea hydraulic power source can become dysfunctional and/or can otherwise no longer be the desired hydraulic power source for a subsea hydraulically powered system. However, rather than recovering the subsea hydraulic power source to the surface for repair or retrofitting with a fluid conduit system 100 as described above and shown in FIGS. 5-15, it can be desirable to deploy an alternative hydraulic power source to replace the functionality of the less preferred hydraulic power source that is already connected to the subsea hydraulically powered system.

Referring now to FIG. 16, a non-functional hydraulic power source 302 is shown as connected to a hydraulically powered system 304 via a conventional fluid conduit 306. In order to supply hydraulic power to the hydraulically powered system 304, the hydraulic power source needs to be disconnected from the hydraulically powered system 304. In this embodiment, an ROV 114 and/or ROM 112 as previously described are utilized to unscrew a threaded connector of the conventional fluid conduit 306 from the hydraulically powered system 304.

Referring now to FIG. 17, with the conventional fluid conduit 306 decoupled from the hydraulically powered system 304, the non-functional hydraulic power source 302 is shown moved and/or abandoned. In addition, a replacement hydraulic power source 308 is deployed and positioned near the hydraulically powered system 304. In this embodiment, the replacement hydraulic power source 308 includes a fluid conduit system 100 including a QD receptacle 106 attached to a handle 110. In addition, the ROV 114 and/or ROM 112 install a QD plug 108 to hydraulically powered system 304.

Referring now to FIG. 18, because the hydraulically powered system 304 is now outfitted with the QD plug 108, the QD receptacle 106 can be moved substantially into coaxial alignment with the QD plug 108 by an ROV 114 and/or ROM 112 and connected to the QD plug 108 to form a fluid tight seal therebetween, thereby providing fluid communication between the hydraulically powered system 304 and the replacement hydraulic power source 308.

It will be appreciated that while the above-described fluid conduit system 100 is described as being applied to systems related to subsea installations, in alternative embodiments, the fluid conduit system 100 can be implemented in other environments and/or adapted for other environments, such as, but not limited to, space applications.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the invention. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A fluid conduit system for coupling a pair of subsea components, the system comprising:
a fluid conduit;
a first quick disconnect member coupled to a first end of the fluid conduit and configured to releasably mate and engage a second quick disconnect member coupled to one of the pair of subsea components; and
a handle coupled to the first quick disconnect member, wherein the handle is configured to be grasped and manipulated by a subsea ROM.

2. The quick disconnect device of claim 1, wherein the handle is a T-handle.

3. The quick disconnect device of claim 1, wherein the first quick disconnect member comprises a female receptacle and the second quick disconnect member comprises a mating male portion configured to engage the female receptacle.

4. The quick disconnect device of claim 3, wherein the first quick disconnect member includes a release mechanism configured to release the first quick disconnect member from the second quick disconnect member in response actuation of the release mechanism.

5. The quick disconnect device of claim 4, wherein the release mechanism is a slidable sleeve.

6. The quick disconnect device of claim 5, further comprising:
a pulling collar coupled to a slidable sleeve of a release mechanism of the first connection portion.

7. The quick disconnect device of claim 6, further comprising a cable coupled to the pulling collar and configured to be pulled by the subsea ROM to release the first connector portion from the second connector portion.

8. The quick disconnect device of claim 1, wherein the handle extends from the first quick disconnect member in a direction generally away from the second quick disconnect member when the second connector portion is connected to the first connector portion.

9. A method for making a subsea fluid conduit connection, comprising:
(a) connecting a first portion of a two portion quick disconnect device to a subsea component;
(b) connecting a second portion of the two portion quick disconnect device to a fluid conduit; and
(c) releasably connecting the first portion to the second portion subsea with a subsea ROM by inserting the first portion into the second portion.

10. The method of claim 9, further comprising threadably coupling the first portion to the subsea component before (c).

11. The method of claim 9, further comprising:
disconnecting the first portion from the second portion with a subsea ROM by actuating a release mechanism on the first portion.

12. The method of claim 11, wherein the release mechanism is a slidable sleeve disposed about the first portion.

13. The method of claim 9, wherein (a) is performed at the sea surface before (c).

14. A method for replacing a first subsea hydraulic power source connected to a subsea hydraulically powered system with a first fluid conduit, the method comprising:
(a) disconnecting the first fluid conduit from the subsea hydraulically powered system;
(b) deploying a second hydraulic power source subsea, wherein a second fluid conduit has a first end connected to the second hydraulic power source and a second end coupled to a first portion of a two portion quick disconnect device;
(c) coupling a second portion of the two portion quick disconnect device to the hydraulically powered system subsea;
(d) releasably connecting the first portion to the second portion subsea with a subsea ROM after (b).

15. The method of claim 14, further comprising coupling the second fluid conduit to the second hydraulic power source at the sea surface before (b).

16. The method of claim 14, further comprising:
retrieving the first subsea hydraulic power source to the surface after (a);
repairing the first subsea hydraulic power source at the surface to form the second hydraulic power source before (b).

17. The method of claim 14, wherein the second hydraulic power source is a new hydraulic power source.

18. The method of claim 14, wherein the first portion comprises a female receptacle and the second portion comprises a mating male portion; and
wherein (d) comprises inserting the male portion into the female portion.
